(19) United States
(12) Patent Application Publication
(10) Pub. No.: US 2002/0128865 A1
(43) Pub. Date: Sep. 12, 2002

(54) Personal medical database device

(76) Inventor: Thomas W. von Alten, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/802,345

(22) Filed: Mar. 9, 2001

(51) Int. Cl. G06F 17/60

(52) U.S. Cl. 705/2; 707/102

(57) ABSTRACT

The present disclosure relates to a personal medical database device that comprises a connector for interfacing the database device with a reading/writing device and at least one memory device contained within the database device. The memory device holds personal medical information of a user of the database device and normally has a storage density of at least 200 kB/mm³. Typically, the memory device is an ARS device or an MRAM device. With the personal medical database device, the user can maintain and transport detailed records as to his or her medical history and current medical status and further can easily convey all or a portion of this information to a practitioner prior to receiving medical/dental services.

### FIELD OF THE INVENTION

The present disclosure relates to a personal medical database device. More particularly, the present disclosure relates to a small, lightweight device capable of storing a substantial amount of medical information so as to permit the creation of a comprehensive yet portable medical database.

### BACKGROUND OF THE INVENTION

A patient's medical history often may have important implications upon the diagnosis and treatment options available to a medical or dental practitioner. Because of this fact, such practitioners normally request medical information from their patients prior to diagnosing and/or treating them. For instance, it is common for medical and dental practitioners to inquire about patient allergies and the drugs the patient is taking prior to administering drugs to the patient.

Medical information of the type described above is normally obtained from the patient directly, for example, by having the patient complete a questionnaire that queries the patient on information relevant to his or her treatment. If the patient happens to have all of his or her medical records with him or her, this information can be accessed, albeit inefficiently. Far more commonly, however, the patient must rely upon his or her memory alone to supply this information.

Where the patient relies upon memory to provide important medical information, he or she can easily forget information relevant to his or her diagnosis and/or treatment. Furthermore, where the patient is not a doctor, it is likely that the patient would not even realize what information would be important to convey to the attending practitioner. Along the same vein, the patient may recall a particular past ailment and its treatment, but not being a doctor, may not recall the particular treatment procedures used or drugs administered.

Although a patient can try to maintain detailed records as to his or her medical history and convey information based upon these records to avoid relying only on memory, this method of information maintenance and transfer also has significant drawbacks. First, the medical services that have been rendered to the patient have been dispersed in time and space by disparate organizations and individuals. Because of this fact, and because there is no standardized database system currently available in which such information can be stored, bits and pieces of the patient's medical history may be spread all over the country or even the world. Therefore, collection of this information can be difficult. Where the patient can collect the information, there still is no guarantee that complete records of the treatment would be available.

Where a patient is able to obtain complete medical records, their maintenance and utilization are impractical. A medical records file would likely comprise a jumbled mess of papers from several different sources, many containing cryptic, handwritten notes. Accordingly, although a patient could maintain the needed information, it could be difficult to access it when needed. Furthermore, such a records file is not easily transportable. It is therefore unlikely that the patient will have the needed information at hand, particularly in an emergency situation. Medical alert bracelets have proved helpful in such situations, however, their use is limited in that typically only a small amount of information can be provided with them to a medical practitioner.

From the foregoing, it can be appreciated that it would be desirable to have a highly portable personal medical database device with which the user can store detailed personal medical information.

### SUMMARY OF THE INVENTION

The present disclosure relates to a personal medical database device that comprises a connector for interfacing the database device with a reading/writing device and at least one memory device contained within the database device. The memory device holds personal medical information of a user of the database device and has a suitable storage density, for example, but not limited to, at least 200 kB/mm³. Typically, although not necessarily, the memory device is an ARS device, and an MRAM device, or a calibration thereof.

With such a personal medical database device, the user can carry the personal medical database device (e.g., on his or her person) to a medical/dental practitioner, present the personal medical database device to the medical/dental practitioner or a member of the practitioner's staff prior to receiving medical/dental services, permit the practitioner/staff member to review at least a portion of the medical information stored in the personal medical database device, and then receive medical/dental services from the practitioner after the practitioner has fully considered the information presented with the personal medical database. Once the services have been performed, the practitioner and/or the user can store new medical information concerning the medical/dental services in the device.

In view of the above, the user can maintain and transport detailed records as to his or her medical history and current medical status and further can easily convey all or a portion of this information to a practitioner prior to receiving medical/dental services to ensure the practitioner is fully informed prior to rendering a diagnosis and/or treatment.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an example personal medical database device of the present invention.

FIG. 2 is a schematic block diagram of the database device shown in FIG. 1.

FIGS. 3A-3C are schematic views of an example internal structure of a first preferred memory device used in the database device of FIGS. 1 and 2.

FIG. 4 is a schematic view illustrating field emitters reading from storage areas of the memory device of FIGS. 3A-3C.

FIG. 5 is a schematic view illustrating the storage medium of the memory device of FIGS. 3A-3C.

FIG. 6 is a schematic view illustrating an example internal structure of a second preferred memory device used in the personal medical database device shown in FIGS. 1 and 2.

FIG. 7 is a schematic detail view of the memory device shown in FIG. 6.

FIG. 8 is a flow diagram of a method for compiling medical information with the database device shown in FIGS. 1 and 2.

FIG. 9 is a schematic view illustrating communication between the database device shown in FIGS. 1 and 2 and a computing device.

FIG. 10 is a flow diagram of a method for using the database device shown in FIGS. 1 and 2 to convey medical/dental information to a medical or dental practitioner and to record new medical information after medical or dental services are rendered to the patient.

### DETAILED DESCRIPTION

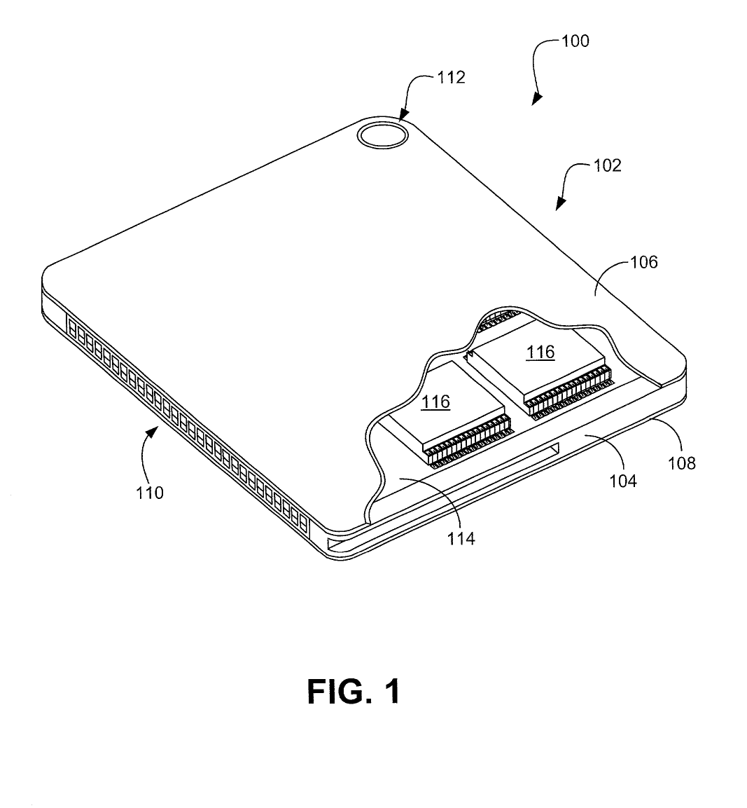

Referring now in more detail to the drawings, in which like numerals indicate corresponding parts throughout the several views, FIG. 1 illustrates a database device 100 that can be used to store personal medical data. It is to be noted that, for the purposes of this disclosure, the term “medical” is used broadly such that, where applicable, the term includes dental and other such quasi-medical activities. Preferably, the database device 100 is small in size so that the user (patient) can easily carry the device wherever he or she goes. For instance, the database device 100 can have a size and configuration similar to that of conventional flash memory cards currently used in digital cameras. By way of example, the database device 100 can have width, length, and thickness dimensions of approximately 1.75 in, 1.5 in, and 0.125 in, respectively. With such small dimensions, the database device 100 can, if desired, be worn on the user's person, for example, around his or her neck, on a bracelet, and so forth. Where it is intended for the user to wear the database device 100, the database device preferably is resistant to shock and water to decrease the chances that the information stored within the device is lost or damaged.

The database device 100 typically comprises a housing 102 that, for example, can comprise a frame 104, and two opposed covers 106 and 108. Normally, the frame 104 includes a connector 110 with which electrical communication can be established with the database device 100. Although a particular type of connector 110 is shown in FIG. 1 for purposes of illustration, it is to be noted that alternative communications means can be used, if desired. By way of example, communication between the database device 100 and another device can be effected through wireless communications. For instance, contactless radio frequency (RF) transmission such as that used with the SmartCard™ system available from Phillips Electronics can be used. In such an implementation, the database device 100 would be highly resistant to water and other environmental contaminants. The opposed covers 106 and 108 can optionally comprise an opening 112 with which the database device 100 can be secured to the user's person, for instance on a necklace or bracelet. As will be appreciated by persons having ordinary skill in the art, the nature and location of such an opening depends upon the nature of the method of securing the database device 100 to the body.

Typically disposed within the housing 102 is a printed circuit board (PCB) 114 that is electrically connected to one or more memory devices 116. Normally, the memory devices 116 are surface mounted to the PCB 114 and electrically connected thereto such that each memory device is in electrical communication with the other memory devices on the board to provide for storage redundancy. Each of the memory devices 116 typically is extremely small in size so that a plurality of such devices can be provided within the housing 102. For instance, each memory device 116 can have width and length dimensions of approximately 1 cm and a thickness dimension of approximately 20 mm. In such an embodiment, approximately five (5) memory devices 116 can be provided within the database device 100. As is discussed in greater detail below, the memory devices 116 preferably comprise memory devices such as atomic resolution storage (ARS) devices or magnetic random access memory (MRAM) devices. In that such memory devices are naturally shock resistant, they are well-suited for portability. By way of example, each memory device 100 has a storage density of at least 200 kilobytes (kB) per cubic millimeter (200 kB/mm³). This density allows construction of a memory device 116 with a capacity of approximately 1 gigabyte (GB). Therefore, where five such devices 116 are provided, a total storage capacity of approximately 5 GB can be achieved.

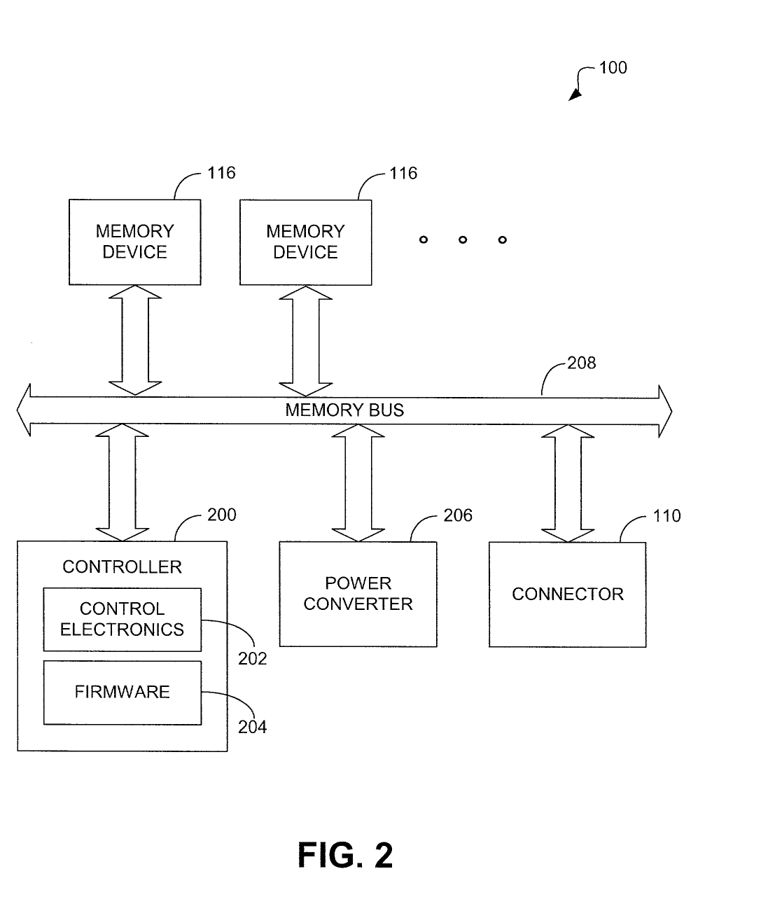

FIG. 2 schematically illustrates the components of the database device 100. As indicated in this figure, the database device 100 typically further includes at least one controller 200. This controller 200 normally comprises a semiconductor device that is electrically connected to the memory devices 116 through the PCB 114 (FIG. 1). By way of example, the controller 200 can comprise an integrated circuit including control electronics 202 and firmware 204 with which the controller interfaces with the memory devices 116 and host device (not shown), for instance a personal computer (PC). With further reference to FIG. 2, the database device 100 can optionally comprise a power converter 206 that increases the voltage received from the host device to ensure that enough power is provided to memory devices 116. Typically, the connector 110, memory devices 116, controller 200, and power converter 206 (if provided) are connected to a memory bus 208 that is formed within the PCB 114 (FIG. 1).

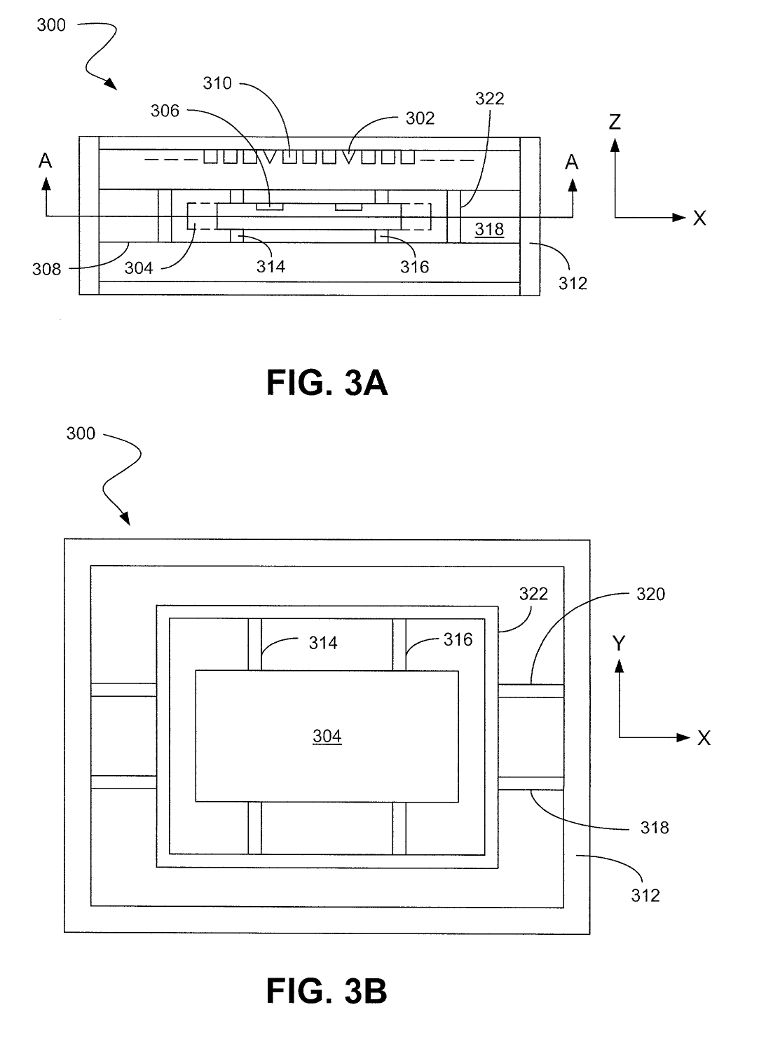

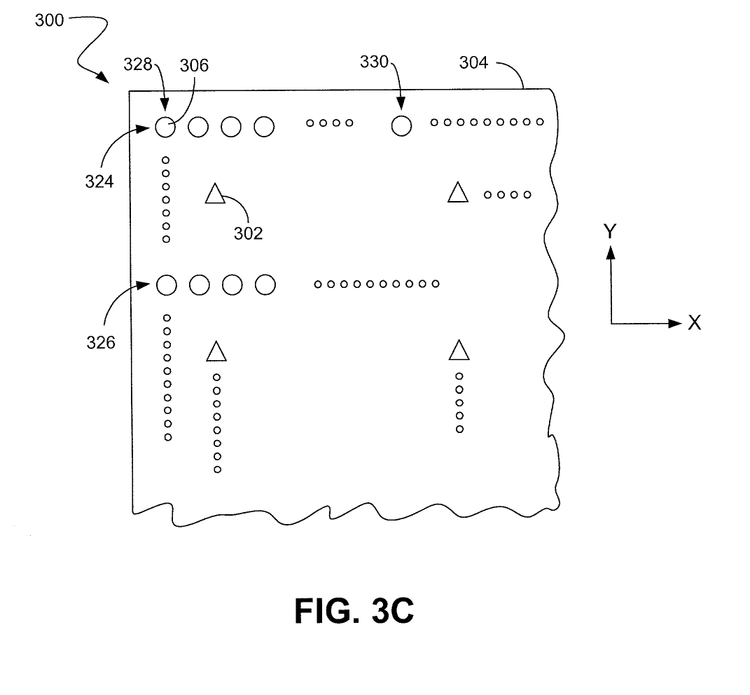

Although the memory devices 116 can comprise substantially any device capable of storing a large amount of data, the memory devices most preferably comprise ARS devices due to their low cost and high capacity. FIGS. 3-5 illustrate the internal structure of an ARS device 300 suitable for construction of the memory devices 116 described above. An example of a suitable ARS device 300 is disclosed and described in detail in U.S. Pat. No. 5,557,596, which is hereby incorporated by reference into the present disclosure. FIG. 3A shows a side cross-sectional view of the ARS device 300. As indicated in this figure, the device 300 includes a number of field emitters 302, a storage medium 304 having a number of storage areas 306, and a micromover 308 which scans the storage medium with respect to the field emitters or vice versa. In a preferred embodiment, each storage area 306 is responsible for storing one bit of information. By way of example, the field emitters 302 can be point-emitters having sharp tips, each tip having a radius of curvature of approximately one nanometer to hundreds of nanometers.

During operation, a predetermined potential difference is applied between a field emitter 302 and a corresponding gate, such as a circular gate 310 which surrounds the emitter. Due to the tip of the emitter 302, an electron beam current is emitted from the emitter towards the storage area 306. Depending upon the distance between the emitters 302 and the storage medium 304, the type of emitters, and the spot size (e.g., bit size) required, electron optics may be useful in focusing the electron beams. Voltage may also be applied to the storage medium 304 to either accelerate or decelerate the field's emitted electrons, or to aid in focusing the field emitted electrons. In a preferred embodiment, a casing 312 maintains the storage medium 304 in a partial vacuum, such as at least 10⁻⁵torr.

In the embodiment shown in FIG. 3A, each field emitter 302 is associated with a corresponding storage area 306. As the micromover 308 scans the medium 304 to different locations, each emitter 302 is positioned above different storage areas 306. With the micromover 308, an array of field emitters 302 can scan over the storage medium 304. The field emitters 302 are responsible for reading and writing information on the storage areas 306 by means of the electron beams they produce. Thus, the field emitters 302 are preferably of the type that produce electron beams that are narrow enough to achieve the desired bit density of the storage medium 304, and which provide the power density of the beam current needed for reading from and writing to the medium. A variety of methods are known in the art which are suitable for making such field emitters 302.

In a preferred embodiment, there can be a two-dimensional array of emitters 302. For instance, an array of 100×100 field emitters 302 can be provided with an emitter pitch of approximately 15 micrometers in both the X and Y directions. Each emitter 302 may access bits in tens of thousands to hundreds of millions of storage areas 306. For example, the emitters 302 can scan over the storage medium 304 (which has a twodimensional array of storage areas 306) with a periodicity of approximately 1 to 100 nanometers between any two storage areas 306, and the range of the micromover can be approximately 15 micrometers. Each of the field emitters 302 can be addressed simultaneously or in a multiplexed manner. As will be appreciated by persons having ordinary skill in the art, a parallel accessing scheme significantly reduces access time and increases the data rate of the storage devices 116. A preferred micromover 308 preferably has sufficient range and resolution to position the field emitters 302 over the storage areas 306 with high accuracy. As a conceptual example, the micromover 308 can be fabricated through a standard semiconductor microfabrication process to scan the medium 304 in the X and Y directions with respect to the casing 312.

FIG. 3B shows a top view of the cross-section A-A of FIG. 3A. As indicated in this figure, the storage medium 304 can be supported by two sets of thin-walled microfabricated beams 314-320. The faces of the first set (314 and 316) of thin-walled beams are in the X-Z. This first set of beams can be flexed in the X direction to allow the medium 304 to move in the X direction with respect to the casing 312. The faces of the second set (318 and 320) of thin-walled beams are in the X-Z plane. This second set of beams allows the medium 304 to be displaced in the Y direction with respect to the casing 312. As further indicated in FIG. 3B, the beams 314-320 can each be connected to a frame 322, the second set (318 and 320) of beams being connected to the casing 312. With this arrangement, the field emitters 302 can scan over the storage medium 304, or the storage medium can scan over the field emitters 302, in the X-Y directions by, for instance, electrostatic, electromagnetic, or piezoelectric means known in the art.

FIG. 3C shows a top view of the ARS device storage medium 304, and illustrates a two-dimensional array of storage areas 306 as well as a two-dimensional array of field emitters 302. To reduce the number of external circuits, the storage medium 304 can be include separate rows, e.g. 324 and 326, of storage areas 306 such that each emitter 302 is responsible for a number of rows. However, in a preferred an embodiment, each emitter 302 need is only responsible for a portion of the entire length of its associated rows. For example, each field emitter 302 can be responsible for the storage areas 306 for its associated rows up along columns 328 and 330. Preferably, each row of storage areas accessed by a single field emitter 302 is connected to a single external circuit. To address a storage area 306, the emitter 302 responsible for that storage area is activated and is displaced with the micromover 308 to that storage area 306.

In use, writing is accomplished by temporarily increasing the power density of the electron beam current to modify the surface state of the storage area 306. Reading, on the other hand, is accomplished by observing the effect of the storage area 306 on the electron beams, or the effect of the electron beams on the storage area. Reading is typically accomplished by collecting the secondary and/or backscattered electrons when an electron beam with a lower power density is applied to the storage medium 304. During reading, the power density of the electron beam is kept low enough so that no further writing occurs. In one preferred embodiment, the storage medium 304 is constructed of a material whose structural state can be changed from crystalline to amorphous by electron beams. The amorphous state has a different secondary electron emission coefficient and backscattered electron coefficient than the crystalline state. This leads to a different number of secondary and backscattered electrons emitted from the storage area 306. By measuring the number of secondary and backscattered electrons, the state of the storage area 306 can be determined. To change from the amorphous to the crystalline state, the beam power density can be increased and then slowly decreased. This increase/decrease heats the amorphous area and then slowly cools it so that the area has time to anneal into its crystalline state. To change from the crystalline to amorphous state, the beam power density is increased to a high level and then rapidly. An example of one such type of material is germanium telluride (GeTe) and ternary alloys based on GeTe.

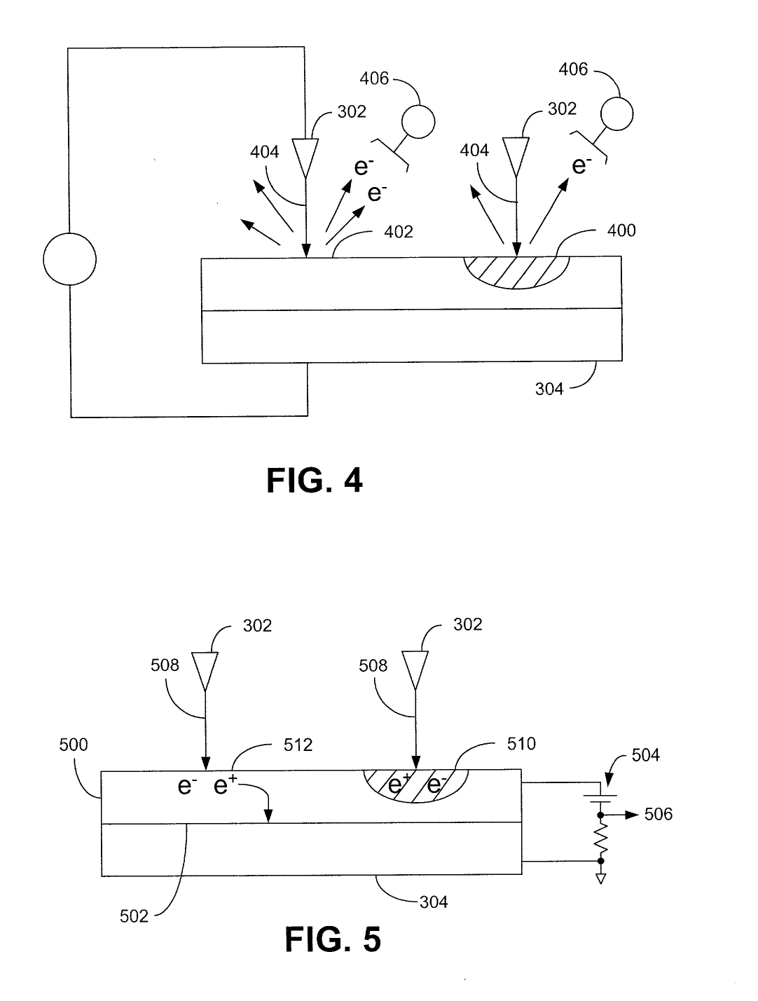

FIG. 4 schematically illustrates field emitters 302 reading from the storage medium 304. In this figure, the state of one particular storage area 400 has been altered, while the state of another particular storage area 402 has not. When a beam 404 of electrons bombard a storage area 306 (FIG. 3C), both the secondary electrons and backscattered electrons are collected by electron collectors 406. As will be appreciated by persons having ordinary skill in the art, a storage area that has been modified (e.g., area 400) will produce a different number of secondary electrons and backscattered electrons, as compared to an area that has not been modified (e.g., area 402). The number may be greater or lesser depending upon the type of material and the type of modification made. By monitoring the magnitude of the signal current collected by the electron collectors 404, the state of and, in turn, the bit stored in the storage area 306 can be identified.

FIG. 5 illustrates a diode approach for construction of the ARS device 300. In this approach, the storage medium 304 is based on a diode structure 500, which can, for example, comprise a PN junction, a schottky, barrier, or substantially any other type of electronic valve. Although FIG. 5 illustrates a particular external circuit 502, it will be appreciated that this circuit is provided for purposes of example only. In the diode approach, bits are stored by locally altering the surface of the diode 500 in such a way that collection efficiency for minority carriers generated by the altered region is different from that of an unaltered region. The collection efficiency for minority carriers can be defined as the fraction of minority carriers generated by the instant electrons that are swept across the diode junction 502 when it is biased by the external circuit 504 to cause a signal current 506 to flow through the external circuit. In use, the field emitters 302 emit narrow beams 508 of electrons onto the surface of the diode 500 that excite electron-hole pairs near the surface of the diode. Because the diode 500 is reverse-biased by the external circuit 504, the minority carriers that are generated by the incident electrons are swept toward the diode junction 502. Electrons that reach the junction 502 are then swept across the junction. Accordingly, minority carriers that do not recombine with majority carriers before reaching the junction 502 are swept across the junction, causing a current flow in the external circuit 504.

Writing onto the diode 500 is accomplished by increasing the power density of the electron beam 508 enough to locally alter the physical properties of the diode. This alteration affects the number of minority carriers swept across the junction 502 when the same area is radiated with a lower power density read electron beam. For instance, the recombination rate in a written area 510 could be increased relative to an unwritten area 512 so that the minority carriers generated in the written area have an increased probability of recombining with minority carriers before they have a chance to reach and cross the junction 502. Hence, a smaller current flows in the external circuit 504 when the read electron beam is incident upon a written area 510 than when it is incident upon an unwritten area 512. Conversely, it is also possible to start with a diode structure having a high recombination rate and to write bits by locally reducing the recombination rate. The magnitude of the current resulting from the minority carriers depends upon the state of the storage area 306, and the current continues the output signal 506 to indicate the bit stored.

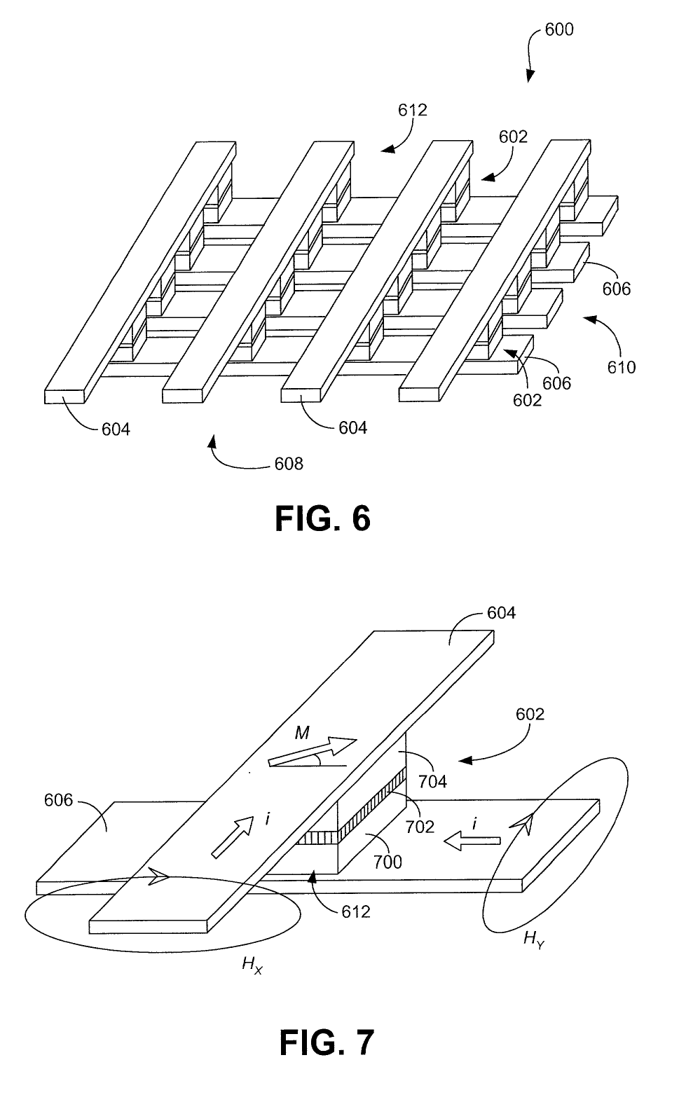

In an alternative preferred arrangement, the memory devices 116 comprise MRAM devices. FIGS. 6 and 7 illustrate the internal structure of an MRAM device 600 suitable for construction of the memory devices 116. As indicated in FIG. 6, the MRAM device 600 comprises a plurality of cells 602, which serve as magnetic domains, and a plurality of conductor bars 604 and 606. Typically, the bars 604, 606 are arranged in first and second parallel planes 608 and 610 with the bars of the first plane aligned perpendicularly to the bars of the second plane. Because of this perpendicular arrangement, the bars 604, 606 form crossover points 612. As is illustrated in FIG. 6, one cell 602 is normally disposed intermediate the two planes 608, 610 at each crossover point 612 formed by the bars 604, 606. Therefore, as shown in the detail view of FIG. 7, each cell 602 is sandwiched between a first bar 604 and a second bar 606 at the two bars' crossover point 612. As indicated in FIG. 7, each cell 602 normally comprises a pinned magnetic layer 700 (i.e., a layer which is permanently magnetized in a predetermined direction), a relatively thin dielectric layer 702, and a free magnetic sense layer 704 (i.e., a layer whose magnetization direction can be selectively changed). By way of example, the bars 604, 606 and their associated cells 602 can be formed on one or more substrates to create an integrated device.

In use, writing is accomplished by passing current, i, through the conductor bars 604, 606 to create magnetic fields Hₓ and H_{y}. These magnetic fields produce resultant vector addition magnetic forces, M, at the crossover points 612 that are sufficient to selectively cause the magnetic orientation of the sense layers 704 to either coincide with the magnetic direction of the pinned magnetic layer 700 or to oppose it. Detection of the written state of the sense layer's magnetism can then be accomplished by determining the differential resistance in the tunneling magneto-resistive junction between the two conductor bars 604, 606 through the sense layer 704, the dielectric layer 702, and the pinned layer 700 depending upon the pinned layer's magnetic orientation.

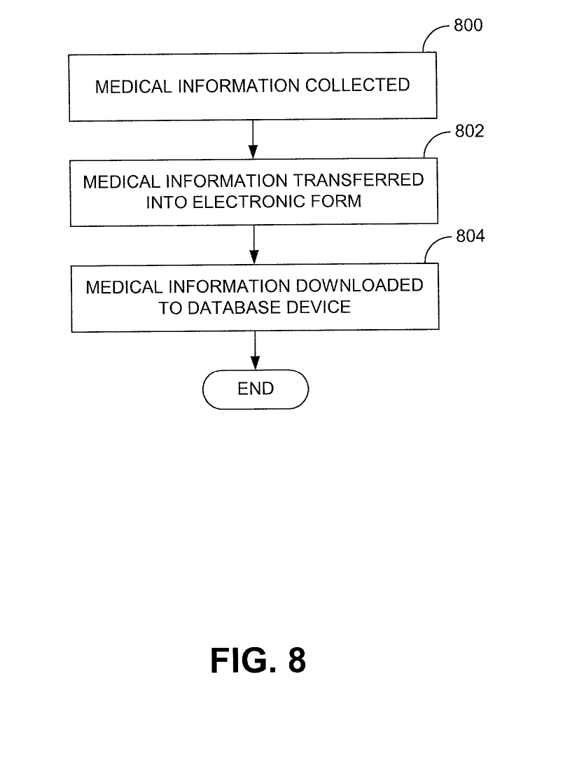

Irrespective of the technology used to construct the memory devices 116, the database device 100 is used to store medical information that the user deems important. For instance, the database device 100 can contain personal medical/dental information including a comprehensive medical/dental history as well as current medical/dental conditions. FIG. 8 illustrates a method for compiling medical information in the creation of a personal medical database with the database device 100. At least initially, it may be useful for the user to store as all medical history information that he or she deems to be relevant to future diagnoses or treatment. The first step, therefore, may be for the user to collect as much medical information to which he or she may have access, as indicated in block 800. Because, as discussed above, it can be difficult to collect information on past treatments, etc., it is noted that the user may choose to only store new and current information with the device 100.

Due to the high capacity achievable with the memory devices 116 identified above, a large amount of information can be stored with the database device 100. Therefore, the user may wish to collect information including immunization records, history as to illnesses experienced, past check-up information (height, weight, etc.), current diseases or medical conditions, drug allergies, medications currently being taken and known contraindications for those medications, family history of diseases, etc. Because of the large capacity of the memory devices 116, the records collected for storage can be textual as well as pictorial in nature. Hence, in addition to written information, the information can include x-rays, CAT scans, PET scans, MRI scans, photographs, doctor sketches, and so forth. Furthermore, the user may wish to consider compiling other information that may be relevant to medical or dental treatment such as emergency contact information, insurance information, as well as organ donor preferences, if any.

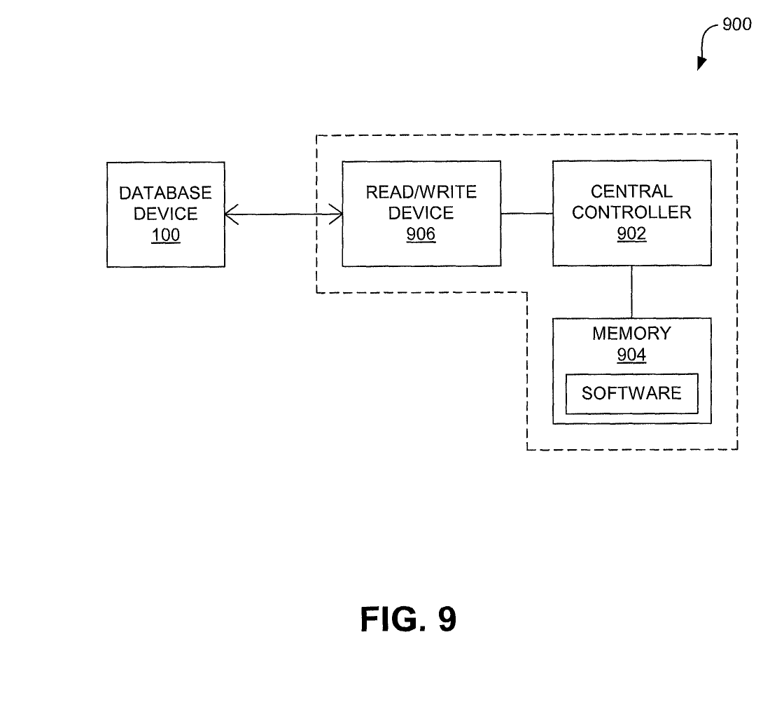

Once all the information has been collected and arranged, the user can then transfer the information into electronic form, as indicated in block 802. Normally, this is accomplished through the use of a computing device such as a PC. FIG. 9 illustrates an example computing device 900 that can be used for this purpose. As indicated in this figure, the computing device 900 normally includes a central controller (e.g., a central processing unit) 902, memory 904, and an appropriate reading/writing device 906. The memory 904 preferably contains software for receiving medical information and data files, as well as software for transferring information to the database device 100.

As will be appreciated by persons having ordinary skill in the art, transfer of the collected information into electronic form can be achieved through several different known methods. For instance, this information can be manually entered into an appropriate software program stored in the computing device memory 904. By way of example, such a program could comprise standardized templates having fields for certain medical information. Although such data entry could be time-consuming, especially where a large amount of information is to be input, it provides the advantage of standardizing the format of the information to permit easier access of information on the part of the practitioner and/or practitioner's staff. Alternatively or in addition, digital images of medical records can be scanned into electronic form with an appropriate scanning device (not shown). In any case, a copy of the information can be stored (at least temporarily) within the memory 904 of the computing device 900. If maintained, this electronic copy of the information provides the user with an additional database of information that can be relied upon should his or her database device 100 become lost or damaged.

After being transferred to the computing device 900, the medical information may be downloaded to the database device 100, as indicated in block 804 of FIG. 8. With reference back to FIG. 9, this task is accomplished with the reading/writing device 906. Prior to downloading, the user can be prompted to enter a password and/or passcode to gain access to the database device 100. Where the user is downloading information to the device 100 for the first time, the user can be prompted to select this password and/or passcode. With such password/passcode protection, security against gaining unauthorized access to or tampering with the user's medical information can be provided. Preferably, the information is stored to the database device 100 with the reading/writing device 906 in a write-protected format such that overwriting of the downloaded information is prohibited. Optionally, overwriting can be permitted for certain files if an appropriate password/passcode is first provided.

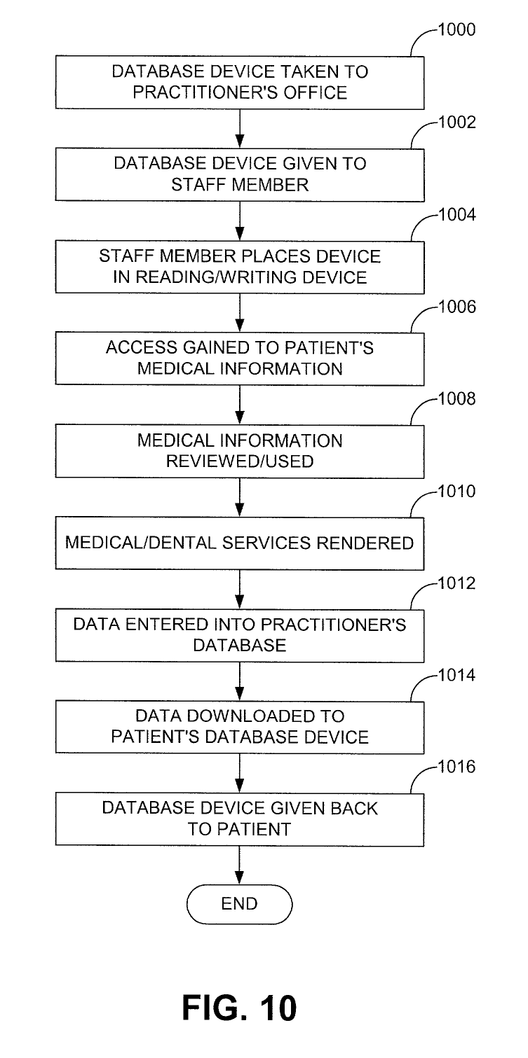

FIG. 10 illustrates a method for using the database device 100 to convey medical information to a practitioner. As identified in block 1000, the user brings the database device 100 along to a practitioner's office prior to diagnosis and/or treatment. Preferably, the database device 100 is carried on the user's person in the manner described above such that the medical information will be available even in the event of a sudden medical emergency. Alternatively, the user can merely carry the database device 100 to a practitioner's office in the common office visit scenario. Upon arrival at the practitioner's office, the user can give the database device 100 to a member of the practitioner's staff, as identified in block 1002, who can insert the device into an appropriate reading/writing device similar to that described above in relation to FIG. 9, as identified in block 1004. At this point, the staff member can attempt to gain access to the information stored on the device 100.

Access can be obtained by the staff member in several different ways. In a first alternative, the user (now patient) can enter his or her password/passcode in secret (e.g., through a shielded keypad) to grant access to the staff or practitioner. In a second alternative, the database device 100 can be configured to additionally recognize and acknowledge a further password/passcode provided only to medical/dental professionals. In yet a further alternative, the database device 100 can be configured to only recognize and acknowledge the medical/dental password/passcode to prevent alteration of medical records after they have been stored with the device. Additionally, the database device 100 can be configured to grant access according to a hierarchical arrangement such that certain practitioners are given a greater amount of access than others. In such an arrangement, maximum patient privacy is maintained while still conveying the information that the practitioner needs.

After access has been gained to the medical information, as indicated in block 1006, the information can be utilized, as indicated in block 1008. If the information is stored in a standardized template as discussed above, the transfer of the medical information, or portions thereof, to the practitioner's database can be quickly accomplished. Optionally, a predetermined duration of time (e.g., one hour) for the availability of the patient's information can be established such that the information will expire after the time limit has passed. In this manner, the patient can be afforded better security for his or her medical information, and the practitioner's databases are not overloaded. Alternatively, provision can be made such that the database device 100 cannot be copied (except to RAM), and the medical information instead read from the device directly.

Once the initial information has been provided to the practitioner, the medical/dental services can be rendered to the patient, as indicated in block 1010. These services can include substantially any medical or dental activities ranging from a mere dental check-up to a complex surgical procedure. Regardless, information as to the services is recorded in the practitioner's database, as indicated in block 1012 and, once recorded, can be downloaded to the database device 100 (block 1014) in similar manner to the initial downloading procedure described above. In addition, any prescriptions provided by the practitioner can be stored on the device and signed with a digital signature. At this point, the device 100 can be given back to the user, as indicated in block 1016, to provide the user with a complete record of his or her diagnosis and treatment and, if applicable, a prescription that can be read and verified by a pharmacist having an appropriate reading device. When used in the manner described above for each visit to a medical or dental practitioner, the user will be able to collect a comprehensive database of his or her own medical history. Because of this fact, the user will no longer need to rely upon others' files for this information, or be concerned that his or her practitioner is making a medical/dental determination without being fully informed as to the patient's relevant medical information.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A personal medical database device, comprising:
a connector for interfacing the database device with a reading/writing device; and
at least one memory device contained within the database device, the memory device holding personal medical information of a user of the database device, wherein the memory device has a storage density of at least 200 kB/mm³.

2. The database device of claim 1, wherein the memory device is an ARS device.

3. The database device of claim 1, wherein the memory device is an MRAM device.

4. The database device of claim 1, further comprising a controller contained within the database device that communicates with the reading/writing device.

5. The database device of claim 1, wherein the database device is sized and configured to be worn on the user's person.

6. The database device of claim 1, further comprising a water resistant housing that encapsulates the memory device.

7. The database device of claim 1, wherein the database device is no larger than approximately 1.75×1.5×0.125 inches in size.

8. The database device of claim 1, wherein the database device has a storage capacity of at least 1 GB.

9. The database device of claim 1, wherein the database device has a storage capacity of at least 5 GB.

10. A method for creating a personal medical database for a user, comprising the steps of:
collecting medical information relevant to the user;
converting the medical information into electronic form; and
writing the medical information to a portable personal medical database device having at least one memory device having a storage density of at least 200 kB/mm³.

11. The method of claim 10, wherein the memory device is an ARS device.

12. The method of claim 10, wherein the memory device is an MRAM device.

13. The method of claim 10, wherein the step of transferring the medical information into electronic form comprises entering the information into a standardized database template.

14. The method of claim 10, wherein the step of transferring the medical information into electronic form comprises electronically scanning the information.

15. The method of claim 10, wherein the step of transferring the medical information into electronic form comprises transferring medical history information of the user into electronic form.

16. The method of claim 10, wherein the step of transferring the medical information into electronic form comprises transferring current medical information of the user into electronic form.

17. The method of claim 10, wherein the step of transferring the medical information into electronic form comprises transferring textual information relevant to the user into electronic form.

18. The method of claim 10, wherein the step of transferring the medical information into electronic form comprises transferring pictorial information relevant to the user into electronic form.

19. A method for using a personal medical database device comprising at least one memory device having a storage density of at least 200 kB/mm³, the device holding personal medical information of a user, the method comprising the steps of:
carrying the personal medical database device;
presenting the personal medical database device to a medical/dental practitioner prior to receiving medical/dental services;
permitting the practitioner to review at least a portion of the medical information stored in the personal medical database device; and
receiving medical/dental services from the practitioner.

20. The method of claim 19, wherein the memory device is an ARS device.

21. The method of claim 19, wherein the memory device is an MRAM device.

22. The method of claim 19, wherein the step of carry the personal medical database device comprises wearing the device on the user's person.

23. The method of claim 19, wherein the step of permitting the practitioner to review at least a portion of the medical information comprises the user entering a password/passcode that facilitates access.

24. The method of claim 19, wherein the step of permitting the practitioner to review at least a portion of the medical information comprises the practitioner entering a password/passcode that facilitates access.

25. The method of claim 24, wherein the level of access attained by the practitioner depends upon the password/passcode entered by the practitioner.

26. The method of claim 19, further comprising the step of storing new medical/dental information relevant to the medical/dental services received in the personal medical database device after the medical/dental services have been rendered.
